(19) United States
(12) Patent Application Publication
(10) Pub. No.: US 2014/0008456 A1
(43) Pub. Date: Jan. 9, 2014

(54) Deposition Apparatus

(71) Applicant: SAMSUNG DISPLAY CO., LTD., Yongin-City (KR)

(72) Inventor: Sang Yun Lee, Yongin-City (KR)

(73) Assignee: SAMSUNG DISPLAY CO., LTD., Yongin-City (KR)

(21) Appl. No.: 13/708,494

(22) Filed: Dec. 7, 2012

(30) Foreign Application Priority Data
Jul. 5, 2012 (KR) 10-2012-0073560

(51) Int. Cl. B05B 1/28

(52) U.S. Cl. CPC B05B 1/28
USPC 239/85; 239/79

(57) ABSTRACT

A deposition apparatus includes a deposition source unit for vaporizing a deposition material, a plurality of nozzles disposed on an upper surface of the deposition source unit for spraying the vaporized deposition material onto a substrate facing the upper surface of the deposition source unit, a plurality of angle restriction members disposed on the upper surface of the deposition source unit and located at left and right sides of the nozzles, and a plurality of first heater units, each of which is disposed on an upper surface of a corresponding angle restriction member of the angle restriction members.

### CLAIM OF PRIORITY

This application makes reference to, incorporates the same herein, and claims all benefits accruing under 35 U.S.C. §119 from an application for a DEPOSITION APPARATUS earlier filed in the Korean Intellectual Property Office on 5 Jul. 2012 and there duly assigned Serial No. 10-2012-0073560.

### BACKGROUND OF THE INVENTION

1. Field of the Invention

The present invention relates to a deposition apparatus. More particularly, the present invention relates to a deposition apparatus capable of restricting a spray angle of a deposition material.

2. Description of the Related Art

Recently, an organic light-emitting diode display has been spotlighted as a next generation display device since it has superior brightness and viewing angle, and does not need to include a separate light source when compared to a liquid crystal display device. Accordingly, the organic light-emitting diode display has the advantages of slimness and light weight. In addition, the organic light-emitting diode display has advantageous properties, e.g., fast response speed, low driving voltage, high brightness, etc.

In general, the organic light-emitting diode display includes an organic light emitting device including an anode, an organic emitting layer, and a cathode. A hole and an electron are injected into the organic emitting layer through the anode and the cathode, and are recombined in the organic emitting layer to generate an exciton. The exciton emits energy discharged when an excited state returns to a ground state as light.

The anode and the cathode are formed of a metal thin film or a transparent conductive thin film. The organic emitting layer is configured to include at least one organic thin film. When the organic thin film or the metal thin film is deposited on a substrate of the organic light-emitting diode display, a deposition apparatus is used. The deposition apparatus includes a crucible filled with a deposition material and a nozzle that sprays the deposition material. When the crucible is heated, the deposition material in the crucible is evaporated and the evaporated deposition material is sprayed through the nozzle. The deposition material sprayed from the nozzle is deposited on the substrate, so that the organic thin film is formed.

### SUMMARY OF THE INVENTION

The present disclosure provides a deposition apparatus capable of restricting a spray angle of a deposition material.

Embodiments of the invention provide a deposition apparatus which includes a deposition source unit that vaporizes a deposition material, a plurality of nozzles disposed on an upper surface of the deposition source unit to spray the vaporized deposition material on a substrate facing the upper surface of the deposition source unit, a plurality of angle restriction members disposed on the upper surface of the deposition source unit and located at left and right sides of the nozzles, and a plurality of first heater units, each of which is disposed on an upper surface of a corresponding angle restriction member of the angle restriction members.

The deposition source unit includes a crucible filled with the deposition material and a second heater unit that vaporizes the deposition material.

The first heater units generate a temperature higher than a temperature generated by the second heater.

The angle restriction members include a plurality of first angle restriction members, each of which is disposed at the left side of a corresponding nozzle of the nozzles, and a plurality of second angle restriction members, each of which is disposed at the right side of the corresponding nozzle of the nozzles.

The vaporized deposition material sprayed from the nozzles has a spray angle restricted to a predetermined angle by the first and second angle restriction members.

The substrate includes a plurality of sub-pixel areas in which a plurality of sub-pixels is formed and a plurality of effective deposition areas respectively corresponding to the sub-pixel areas, and each of the effective deposition areas has a width wider than a width of each of the sub-pixel areas.

The predetermined angle is set to an angle to allow the vaporized deposition material to be deposited in the effective deposition areas.

A first height, corresponding to a height between the upper surface of the deposition source unit and the upper surface of the angle restriction members, is set higher than a second height corresponding to a height between the upper surface of the deposition source unit and an upper surface of the nozzles.

Each of the first heater units has a semi-circular shape, a rectangular shape, a square shape, a semi-oval shape, or a rectangular shape with rounded corners.

Embodiments of the invention provide a deposition apparatus which includes a deposition source unit that vaporizes a deposition material, a plurality of nozzles disposed on an upper surface of the deposition source unit to spray the vaporized deposition material on a substrate facing the upper surface of the deposition source unit, a plurality of angle restriction members disposed on the upper surface of the deposition source unit, and a plurality of heater units, each of which is disposed on an upper surface of a corresponding angle restriction member of the angle restriction members. The angle restriction members include a plurality of first angle restriction members disposed between the nozzles, a second angle restriction member located at a right side of a nozzle disposed at a rightmost position among the nozzles, and a third angle restriction member located at a left side of a nozzle disposed at a leftmost position among the nozzles.

Each of the first angle restriction members has a first width smaller than a second width defined by a width between two nozzles adjacent to each other of the nozzles and greater than a half of the second width.

Each of the first angle restriction members has a first width smaller than a half of a second width defined by a width between two nozzles adjacent to each other of the nozzles.

The heater units include a plurality of first sub-heater units, each of which is located at a left portion of the upper surface of a corresponding angle restriction member of the first angle restriction members, the second angle restriction member and the third angle restriction member, and a plurality of second sub-heater units, each of which is located at a right portion of the upper surface of the corresponding angle restriction member of the first angle restriction members, the second angle restriction member and the third angle restriction member.

Each of the heater units covers the upper surface of a corresponding angle restriction member of the first angle restriction members, the second angle restriction member, and the third angle restriction member.

Each of the first angle restriction members, the second angle restriction member, and the third angle restriction member has a T shape.

According to the above, the deposition apparatus restricts the spray angle of the deposition material, and thus the organic material may be deposited in the effective deposition areas.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view showing a deposition apparatus according to a first exemplary embodiment of the present invention;

FIG. 2 is an enlarged view showing a portion of the deposition apparatus shown in FIG. 1;

FIG. 3 is a view showing a deposition apparatus according to a second exemplary embodiment of the present invention;

FIG. 4 is a view showing a deposition apparatus according to a third exemplary embodiment of the present invention;

FIG. 5 is a view showing a deposition apparatus according to a fourth exemplary embodiment of the present invention;

FIG. 6 is a view showing a deposition apparatus according to a fifth exemplary embodiment of the present invention; and

FIG. 7 is a view showing a deposition apparatus according to a sixth exemplary embodiment of the present invention.

### DETAILED DESCRIPTION OF THE INVENTION

It will be understood that, when an element or layer is referred to as being “on”, “connected to” or “coupled to” another element or layer, it can be directly on, connected to or coupled to the other element or layer, or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

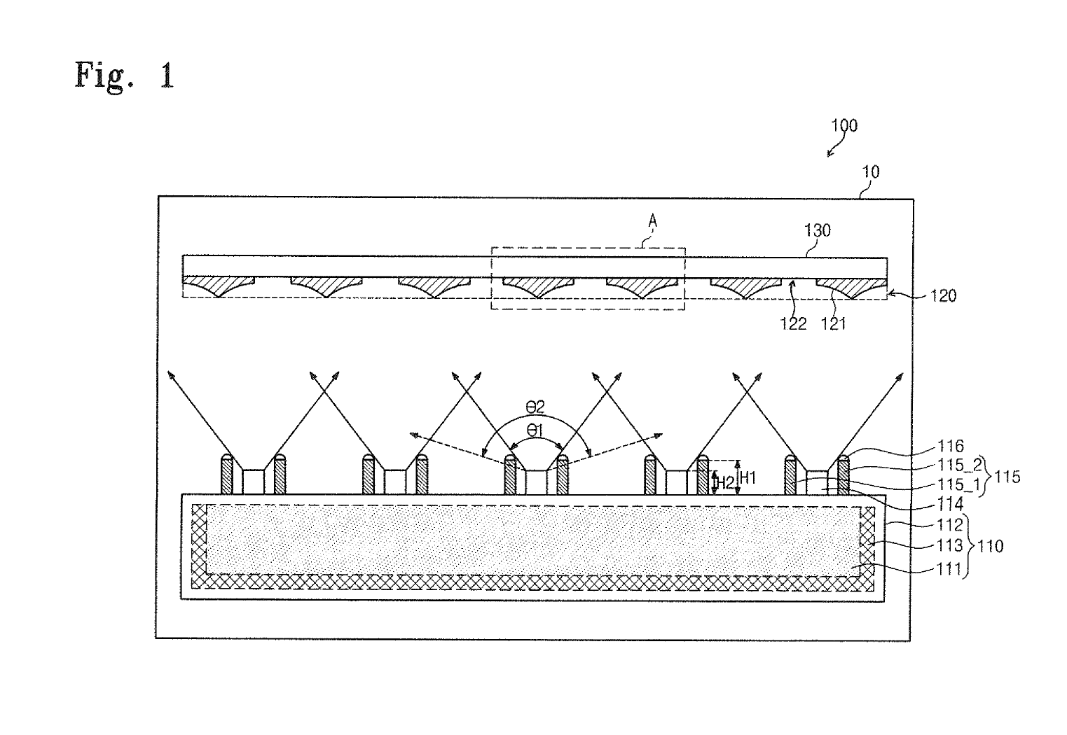

FIG. 1 is a view showing a deposition apparatus according to a first exemplary embodiment of the present invention.

Referring to FIG. 1, a deposition apparatus 100 includes a vacuum chamber 10, a deposition source unit 110, a plurality of nozzles 114, a plurality of angle restriction members 115, a plurality of heater units 116, a fine metal mask 120 (hereinafter, referred to as FMM), and a substrate 130.

For the convenience of explanation, five nozzles 114 and ten angle restriction members 115 have been shown in FIG. 1, but the number of the nozzles 114 and the number of the angle restriction members 115 should not be limited thereto or thereby.

The vacuum chamber 10 maintains a high vacuum state in order to prevent foreign substances from entering the vacuum chamber 10 and to secure straightness of a deposition material. The vacuum chamber 10 maintains the degree of vacuum of about 10E-7 Torr.

The deposition source unit 110 is disposed at a lower portion in the vacuum chamber 10. The deposition material to be deposited on the substrate 130, e.g., an organic material, a metal material, etc., is provided inside the deposition source unit 110. The deposition source unit 110 is configured to vaporize the deposition material.

The substrate 130 is disposed at an upper portion in the vacuum chamber 10 so as to face an upper portion of the deposition source unit 110. The FMM 120 is disposed on the substrate 130 to be attached.

The deposition source unit 110 includes a crucible 112 filled with the deposition material 111 to be deposited on the substrate 130, and a second heater unit 113 used to vaporize the deposition material 111. In the case where the deposition material 111 to be deposited on the substrate 130 is an organic material, an organic thin layer may be formed on the substrate 130. Hereinafter, the organic material will be described as the deposition material 111, but the deposition material 111 should not be limited to the organic material. That is, the deposition material 111 may be a metal material. The second heater unit 113 heats the crucible 112 so as to vaporize the organic material 111 filled inside the crucible 112, so that the vaporized organic material travels to the nozzles 114 disposed on the upper surface of the deposition source unit 110.

The nozzles 114 are disposed on the upper surface of the deposition source unit 110 and spaced apart from each other at regular intervals. The nozzles 114 spray the vaporized organic material 111 in the deposition source unit 110. In detail, the organic material 111 vaporized by the second heater unit 113 is sprayed on the substrate 130 facing the upper surface of the deposition source unit 110 through the nozzles 114.

The angle restriction members 115 are disposed on the upper surface of the deposition source unit 110 and are located at left and right sides of the nozzles 114. That is, each pair of angle restriction members 115 is disposed so as to face each other while interposing a corresponding nozzle of the nozzles 114 therebetween. In detail, the angle restriction members 115 include a plurality of first angle restriction members 115_1, each of which is disposed at the left side of the corresponding nozzle of the nozzles 114, and a plurality of second angle restriction members 115_2, each of which is disposed at the right side of the corresponding nozzle of the nozzles 114.

When a height between the upper surface of the deposition source unit 110 and the upper surface of the first and second angle restriction members 115_1 and 115_2, respectively, is referred to as a first height H1, and a height between the upper surface of the deposition source unit 110 and the upper surface of the nozzles 114 is referred to as a first height H1, the first height H1 is set higher than the second height H2.

The first heater units 116 are disposed on the angle restriction members 115, respectively. In detail, the first heater units 116 are provided on the upper surfaces of the first and second angle restriction members 115_1 and 115_2, respectively, so as to cover the whole upper surfaces of the first and second angle restriction members 115_1 and 115_2, respectively. The first heater units 116 have a semi-circular shape as shown in FIG. 1, but they should not be limited to the semi-circular shape. That is, the first heater units 116 may have various shapes, such as a rectangular shape, a square shape, a semi-oval shape, a rectangular shape with rounded corners, etc.

A spray angle of the organic material 111 sprayed from the nozzles 114 is restricted to a certain angle by the first heater units 116 and the first and second angle restriction members 115_1 and 115_2, respectively, disposed at the left and right sides of the nozzles 114. Each of the first heater units 116 has a constant size regardless of the spray angle of the organic material 111. Each of the first and second angle restriction members 115_1 and 115_2, respectively, is set to a specific size in order to restrict the spray angle of the organic material 111 to the certain angle. That is, substantially, the spray angle of the organic material 111 may be restricted to the certain angle by the first and second angle restriction members 115_1 and 115_2, respectively.

The spray angle of the organic material 111 sprayed from the nozzles 114, which is restricted by the first and second angle restriction members 115_1 and 115_2, respectively, may be a first angle θ1, and the organic material 111 sprayed from the nozzles 114 at the first angle θ1 is represented by a solid arrow line in FIG. 1.

In a case where the first and second angle restriction members 115_1 and 115_2, respectively, do not exist, the spray angle of the organic material 111 sprayed from the nozzles 114 may be a second angle θ2. The organic material 111 sprayed from the nozzles 114 at the second angle θ2 is represented by a dotted arrow line in FIG. 1.

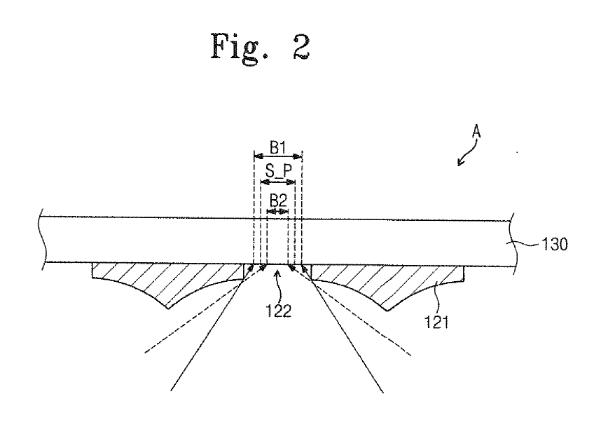

The first angle θ1 is set smaller than the second angle θ2. Preferably, the first angle θ1 may be set to an angle so as to secure an effective deposition area on the substrate 130. The first angle θ1 will be described in detail later with reference to FIG. 2.

As described above, the first height H1 of the first and second angle restriction members 115_1 and 115_2, respectively, is set higher than the second height H2 of the nozzles 114. In addition, the first height H1 of the first and second angle restriction members 115_1 and 115_2, respectively, may be set so as to allow the spray angle of the organic material 111 sprayed from the nozzles 114 to have the first angle θ1. The first and second angle restriction members 115_1 and 115_2, respectively, may be disposed adjacent to the nozzles 114 so that the spray angle of the organic material 111 has the first angle θ1.

For instance, as the first angle θ1 is decreased, the first height H1 of the first and second angle restriction members 115_1 and 115_2, respectively, becomes high, and the first and second angle restriction members 115_1 and 115_2, respectively, are disposed so as to be more adjacent to the nozzles 114. In addition, as the first angle θ1 is increased, the first height H1 of the first and second angle restriction members 115_1 and 115_2, respectively, becomes low, and the first and second angle restriction members 115_1 and 115_2, respectively, are disposed so as to be more separated from the nozzles 114.

The organic material 111 sprayed onto the substrate 130 at the first angle θ1 by the first and second angle restriction members 115_1 and 115_2, respectively, may be stacked up on the first and second angle restriction members 115_1 and 115_2, respectively. When the organic material 111 is stacked up on the first and second angle restriction members 115_1 and 115_2, respectively, the first angle θ1 is changed to an angle different from the predetermined angle. The first heater units 116 heat the first and second angle restriction members 115_1 and 115_2, respectively, at a designated temperature so as to vaporize the organic material 111 stacked up on the first and second angle restriction members 115_1 and 115_2, respectively.

The temperature generated by the first heater units 116 may be set higher than a temperature generated by the second heater unit 113 in order to effectively vaporize the organic material 111 stacked up on the first and second angle restriction members 115_1 and 115_2, respectively.

The FMM 120 includes a shielding portion 121 and an opening portion 122. The organic material 111 sprayed from the nozzles 114 at the first angle θ1 is deposited on the substrate 130 through the opening portion 122 of the FMM120. That is, the organic material 111 passing through the opening 122 of the FMM120 may be deposited on a sub-pixel area of the substrate 130. The FMM 120 is prepared so as to have the same size as the substrate 130. The FMM 120 is arranged on the substrate 130 so as to make contact with the substrate 130.

The deposition apparatus 100 may further include a substrate supporter (not shown) disposed in the vacuum chamber 10 to support an edge portion of the substrate 130. The substrate 130 is a substrate for an organic electroluminescence display device, but it should not be limited thereto or thereby.

FIG. 2 is an enlarged view showing a portion of the deposition apparatus shown in FIG. 1.

Referring to FIG. 2, the substrate 130 includes a first area B1, the sub-pixel area S_P, and a second area B2, which correspond to the opening portion 122 of the FMM 120.

The sub-pixel area S_P is an area in which a sub-pixel is formed. The first area B1 is the effective deposition area. The first area B1 has a width wider than that of the sub-pixel area S_P so as to effectively form the sub-pixel. The opening portion 122 of the FMM 120 allows the organic material 111 to be deposited in a specific area of the substrate 130.

For convenience of explanation, one first area B1 and one sub-pixel area S_P are shown in FIG. 2. However, since the opening portion 122 is provided in a plural number in the FMM 120, the substrate 130 may include a plurality of first areas B1 and a plurality of sub-pixel areas S_P respectively corresponding to the first areas B1.

As described above, the solid arrow line shown in FIG. 2 represents the organic material 111 sprayed onto the substrate 130 from the nozzles 140 at the first angle θ1. The dotted arrow line shown in FIG. 2 represents the organic material 111 sprayed onto the substrate 130 from the nozzles 140 at the second angle θ2 when the angle restriction members 115 do not exist.

The spray of the organic material 111 sprayed from the nozzles 114 may be set to an angle by the first and second angle restriction members 115_1 and 115_2, respectively, so as to allow the organic material 111 to be deposited in the effective deposition area. That is, the first angle θ1 may be set to an angle such that the organic material 111 sprayed from the nozzles 114 is deposited in the first area B1. Accordingly, as described above, the spray angle of the organic material 111 sprayed from the nozzles 114 may be the first angle θ1 set by the first and second angle restriction members 115_1 and 115_2, respectively.

The organic material 111 sprayed from the nozzles 114 at the first angle θ1 by the first and second angle restriction members 115_1 and 115_2, respectively, is incident on the first area B1 of the substrate 130 as shown in FIG. 2. Thus, the organic material 111 is deposited in the effective deposition area B1 of the substrate 130.

When the first and second angle restriction members 115_1 and 115_2, respectively, do not exist, the organic material 111 sprayed from the nozzles 114 at the second angle θ1 is deposited in the second area B2 of the substrate 130. The second area B2 has a width smaller than that of the sub-pixel area S_P. Therefore, the organic thin layer is abnormally formed when the angle restriction members 115 do not exist.

Consequently, the deposition apparatus 100 according to the first exemplary embodiment restricts the spray angle of the organic material 111 using the angle restriction members 115, and thus the organic material 111 may be deposited in the effective deposition area of the substrate 130.

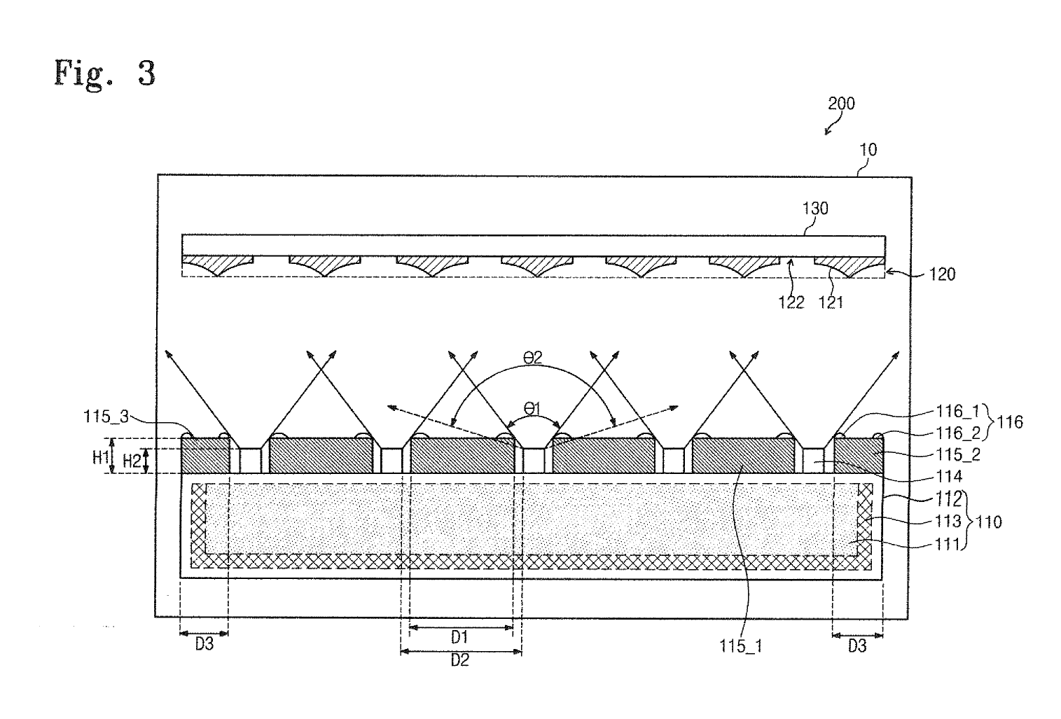

FIG. 3 is a view showing a deposition apparatus according to a second exemplary embodiment of the present invention.

The deposition apparatus 200 shown in FIG. 3 has the same structure and function as those of the deposition apparatus 100 shown in FIG. 1 except for angle restriction members 115_1, 115_2, and 115_3 and first heater units 116. Accordingly, in FIG. 3, the same references denote the same elements shown in FIG. 1. Thus, detailed descriptions of the same elements will be omitted and different features will be mainly described.

Referring to FIG. 3, the angle restriction members 115_1, 115_2, and 115_3 include a plurality of first angle restriction members 115_1 each of which is disposed between the nozzles 114, a second angle restriction member 115_2 located at a right side of a nozzle disposed at a rightmost position of the nozzles 114, and a third angle restriction member 115_3 located at a left side of a nozzle disposed at a leftmost position of the nozzles 114.

Each of the first angle restriction members 115_1 has a first width D1, and two adjacent nozzles are spaced apart from each other by a second width D2. The first width D1 is smaller than the second width D2 and greater than a half of the second width D2. The second and third angle restriction members 115_2 and 115_3, respectively, have the same width, e.g., a third width D3. The first angle restriction members 115_1, the second angle restriction member 115_2, and the third angle restriction member 115_3 have the same height, e.g., a first height H1. The first height H1 is set higher than a second height H2 of the nozzles 114.

The first height H1 and the first width D1 of the first angle restriction members 115_1 and the first height H1 and the third width D3 of the second and third angle restriction members 115_2 and 115_3, respectively, may be set to allow the organic material 111 sprayed from the nozzles 114 to have a first angle θ1 as its spray angle.

For instance, as the first angle θ1 is decreased, the first height H1 of the first angle restriction members 115_1 becomes high and the first width D1 of the first angle restriction members 115_1 becomes wide. Although the first width D1 becomes wide, the first width D1 is set to be smaller than the second width D2. In addition, as the first angle θ1 is decreased, the first height H1 of the second and third angle restriction members 115_2 and 115_3, respectively, becomes high and the third width D3 of the second and third angle restriction members 115_2 and 115_3, respectively, becomes wide.

As the first angle θ1 is increased, the first height H1 of the first angle restriction members 115_1 becomes low and the first width D1 of the first angle restriction members 115_1 becomes narrow. Although the first width D1 becomes narrow, the first width D1 is set to be greater than the half of the second width D2. In addition, as the first angle θ1 is increased, the first height H1 of the second and third angle restriction members 115_2 and 115_3, respectively, becomes low and the third width D3 of the second and third angle restriction members 115_2 and 115_3, respectively, becomes narrow.

Consequently, the spray angle of the organic material 111 sprayed from the nozzles 114 may be restricted to the first angle θ1 by the first angle restriction members 115_1, the second angle restriction member 115_2, and the third angle restriction member 115_3.

As described above with reference to FIG. 1, the first angle θ1 is set to be smaller than the second angle θ2. Preferably, the first angle θ1 may be set to an angle to secure the effective deposition area on the substrate 130. That is, the organic material 111 sprayed from the nozzles 114 at the first angle θ1 may be deposited in the effective deposition area of the substrate 130.

The first heater units 116 include a plurality of first sub-heater units 116_1, each of which is located at a left portion of an upper surface of a corresponding angle restriction member of the first, second, and third angle restriction members 115_1, 115_2, and 115_3, respectively, and a plurality of second sub-heater units 116_2, each of which is located at a right portion of the upper surface of the corresponding angle restriction member of the first, second, and third angle restriction members 115_1, 115_2, and 115_3, respectively.

The organic material 111 sprayed onto the substrate 130 at the first angle θ1 may be stacked up on the first, second, and third angle restriction members 115_1, 115_2, and 115_3, respectively. The first and second sub-heater units 116_1 and 116_2, respectively, heat the first, second, and third angle restriction members 115_1, 115_2, and 115_3, respectively, at a designated temperature so as to vaporize the organic material 111 stacked up on the first, second, and third angle restriction members 115_1, 115_2, and 115_3, respectively. The temperature generated by the first and second sub-heater units 116_1 and 116_2, respectively, may be set higher than a temperature generated by the second heater unit 113 in order to effectively vaporize the organic material 111 stacked up on the first, second, and third angle restriction members 115_1, 115_2, and 115_3, respectively.

Consequently, the deposition apparatus 200 according to the second exemplary embodiment restricts the spray angle of the organic material 111 using the first, second, and third angle restriction members 115_1, 115_2, and 115_3, respectively, and thus the organic material 111 may be deposited in the effective deposition area of the substrate 130.

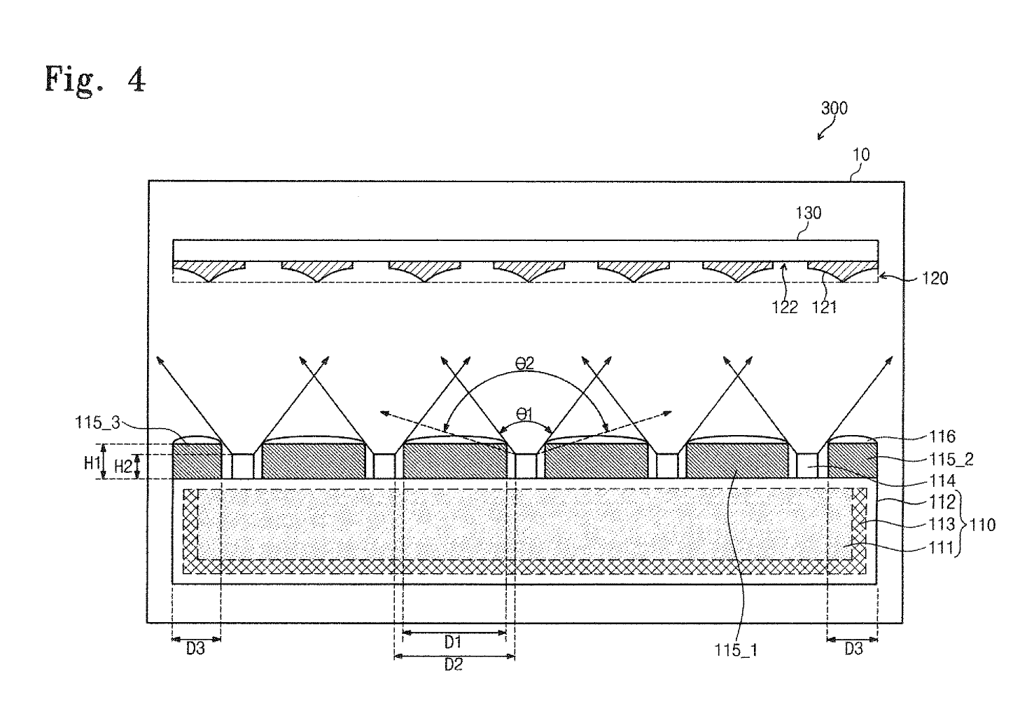

FIG. 4 is a view showing a deposition apparatus according to a third exemplary embodiment of the present invention.

The deposition apparatus 300 shown in FIG. 4 has the same structure and function as those of the deposition apparatus 200 shown in FIG. 3 except for first heater units 116. Accordingly, in FIG. 4, the same references denote the same elements shown in FIG. 3. Thus, detailed descriptions of the same elements will be omitted and different features will be mainly described.

Referring to FIG. 4, each of the first heater units 116 is formed to cover the whole upper surface of a corresponding angle restriction member among first, second, and third angle restriction members 115-1, 115-2, and 115-3, respectively. Other parts of the deposition apparatus 300 have the same structure and function as those of the deposition apparatus 200 shown in FIG. 3, and thus detailed descriptions of the other parts will be omitted.

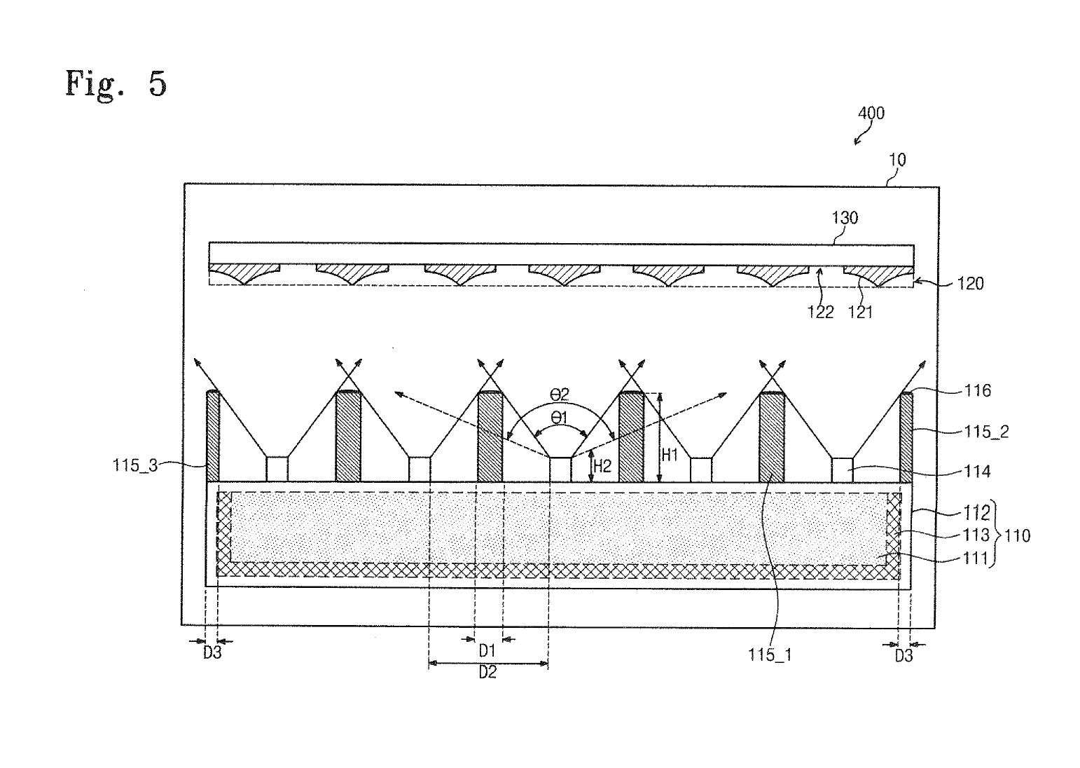

FIG. 5 is a view showing a deposition apparatus according to a fourth exemplary embodiment of the present invention.

The deposition apparatus 400 shown in FIG. 5 has the same structure and function as those of the deposition apparatus 200 shown in FIG. 3 except for angle restriction members 115-1, 115-2, and 115-3, respectively, and first heater units 116. Accordingly, in FIG. 5, the same references denote the same elements shown in FIG. 3, and thus, detailed descriptions of the same elements will be omitted and different features will be mainly described.

Referring to FIG. 5, the angle restriction members 115_1, 115_2, and 115_3 include a plurality of first angle restriction members 115_1 each of which is disposed between the nozzles 114, a second angle restriction member 115_2 disposed at a right side of a nozzle disposed at a rightmost position of the nozzles 114, and a third angle restriction member 115_3 disposed at a left side of a nozzle disposed at a leftmost position of the nozzles 114.

The angle restriction members shown in FIG. 5 have a narrower width and a higher height than those of the angle restriction members shown in FIGS. 3 and 4.

Each of the first angle restriction members 115_1 has a first width D1, and two adjacent nozzles are spaced apart from each other by a second width D2. The first width D1 is set to smaller than a half of the second width D2. The second and third angle restriction members 115_2 and 115_3, respectively, have the same width, e.g., a third width D3. In addition, the first angle restriction members 115_1, the second angle restriction member 115_2, and the third angle restriction member 115_3 have the same height, e.g., a first height H1.

The first height H1 and the first width D1 of the first angle restriction members 115_1 and the first height H1 and the third width D3 of the second and third angle restriction members 115_2 and 115_3, respectively, may be set to allow the organic material 111 sprayed from the nozzles 114 to have a first angle θ1 as its spray angle.

For instance, as the first angle θ1 is decreased, the first height H1 of the first angle restriction members 115_1 becomes high and the first width D1 of the first angle restriction members 115_1 becomes wide. Although the first width D1 becomes wide, the first width D1 is set to be smaller than the half of the second width D2. In addition, as the first angle θ1 is decreased, the first height H1 of the second and third angle restriction members 115_2 and 115_3, respectively, becomes high and the third width D3 of the second and third angle restriction members 115_2 and 115_3, respectively, becomes wide.

As the first angle θ1 is increased, the first height H1 of the first angle restriction members 115_1 becomes low and the first width D1 of the first angle restriction members 115_1 becomes narrow. In addition, as the first angle θ1 is increased, the first height H1 of the second and third angle restriction members 115_2 and 115_3, respectively, becomes low and the third width D3 of the second and third angle restriction members 115_2 and 115_3, respectively, becomes narrow.

Consequently, the spray angle of the organic material 111 sprayed from the nozzles 114 may be restricted to the first angle θ1 by the first angle restriction members 115_1, the second angle restriction member 115_2, and the third angle restriction member 115_3.

As described above, the first angle θ1 is set to be smaller than the second angle θ2. Preferably, the first angle θ1 may be set to an angle so as to secure the effective deposition area on the substrate 130. That is, the organic material 111 sprayed from the nozzles 114 onto the substrate 130 at the first angle θ1 may be deposited in the effective deposition area of the substrate 130.

Each of the first heater units 116 is formed on a corresponding angle restriction member of the first, second, and third angle restriction members 115_1, 115_2, and 115_3, respectively, so as to cover the whole upper surface of the corresponding angle restriction member of the first, second, and third angle restriction members 115_1, 115_2, and 115_3, respectively. The first heater units 116 heat the first, second, and third angle restriction members 115_1, 115_2, and 115_3, respectively, at a designated temperature so as to vaporize the organic material 111 stacked up on the first, second, and third angle restriction members 115_1, 115_2, and 115_3, respectively. The temperature generated by the first heater units 116 may be set higher than a temperature generated by the second heater unit 113 in order to effectively vaporize the organic material 111 stacked up on the first, second, and third angle restriction members 115_1, 115_2, and 115_3, respectively.

Consequently, the deposition apparatus 400 according to the fourth exemplary embodiment restricts the spray angle of the organic material 111 using the first, second, and third angle restriction members 115_1, 115_2, and 115_3, respectively, and thus the organic material 111 may be deposited in the effective deposition area of the substrate 130.

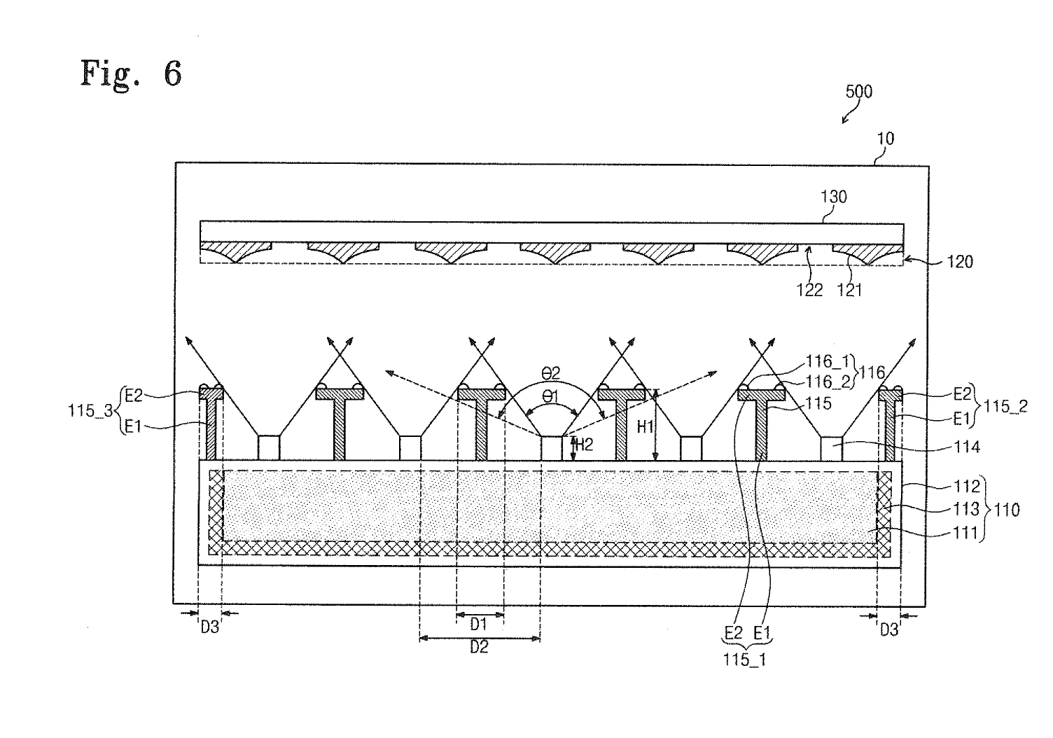

FIG. 6 is a view showing a deposition apparatus according to a fifth exemplary embodiment of the present invention.

The deposition apparatus 500 shown in FIG. 6 has the same structure and function as those of the deposition apparatus 200 shown in FIG. 3 except for angle restriction members 115_1, 115_2, and 115_3. Accordingly, in FIG. 6, the same references denote the same elements shown in FIG. 3, and thus, detailed descriptions of the same elements will be omitted and different features will be mainly described.

Referring to FIG. 6, the angle restriction members 115_1, 115_2, and 115_3 include a plurality of first angle restriction members 115_1, each of which is disposed between the nozzles 114, a second angle restriction member 115_2 disposed at a right side of a nozzle disposed at a rightmost position of the nozzles 114, and a third angle restriction member 115_3 disposed at a left side of a nozzle disposed at a leftmost position of the nozzles 114.

Each of the first, second, and third angle restriction members 115_1, 115_2, and 115_3, respectively, has a T shape. In detail, each of the first, second, and third angle restriction members 115_1, 115_2, and 115_3, respectively, includes a first extension portion E1 extending upwardly and a second extension portion E2 extending in left and right directions at an upper portion of the first extension portion E1. The first, second, and third angle restriction members 115_1, 115_2, and 115_3, respectively, are disposed on the upper surface of the deposition source unit 110.

The second extension portion E2 of each of the first angle restriction members 115_1 has a first width D1, and two adjacent nozzles are spaced apart from each other by a second width D2. The first width D1 is smaller than the second width D2. The second extension portion E2 of each of the second and third angle restriction members 115_2 and 115_3, respectively, has a uniform width, e.g., a third width D1

The first angle restriction members 115_1, the second angle restriction member 115_2, and the third angle restriction member 115_3 have the same height, e.g., a first height H1. The first height H1 corresponds to a height between the upper surface of the deposition source unit 110 and an upper surface of the second extension portion E2 of the first, second, and third angle restriction members 115_1, 115_2, and 115_3, respectively. The first height H1 of the first, second, and third angle restriction members 115_1, 115_2, and 115_3, respectively, is set higher than a second height H2 of the nozzles 114.

The first height H1 of the first angle restriction members 115_1, the first width D1 of the second extension portion E2 of the first angle restriction members 115_1, and the third width D3 of the second extension portion E2 of the second and third angle restriction members 115_2 and 115_3, respectively, may be set to allow the organic material 111 sprayed from the nozzles 114 to have a first angle θ1 as its spray angle.

For instance, as the first angle θ1 is decreased, the first height H1 of the first angle restriction members 115_1 becomes high and the first width D1 of the second extension portion E2 of the first angle restriction members 115_1 becomes wide. Although the first width D1 becomes wide, the first width D1 is set to be smaller than the second width D2. In addition, as the first angle θ1 is decreased, the first height H1 of the second and third angle restriction members 115_2 and 115_3, respectively, becomes high and the third width D3 of the second extension portion E2 of the second and third angle restriction members 115_2 and 115_3, respectively, becomes wide.

As the first angle θ1 is increased, the first height H1 of the first angle restriction members 115_1 becomes low and the first width D1 of the second extension portion E2 of the first angle restriction members 115_1 becomes narrow. In addition, as the first angle θ1 is increased, the first height H1 of the second and third angle restriction members 115_2 and 115_3, respectively, becomes low and the third width D3 of the second extension portion E2 of the second and third angle restriction members 115_2 and 115_3, respectively, becomes narrow.

Consequently, the spray angle of the organic material 111 sprayed from the nozzles 114 may be restricted to the first angle θ1 by the first angle restriction members 115_1, the second angle restriction member 115_2, and the third angle restriction member 115_3.

As described above, the first angle θ1 is set to be smaller than the second angle θ2. Preferably, the first angle θ1 may be set to an angle so as to secure the effective deposition area on the substrate 130. That is, the organic material 111 sprayed from the nozzles 114 at the first angle θ1 may be deposited in the effective deposition area of the substrate 130.

Consequently, the deposition apparatus 500 according to the fifth exemplary embodiment restricts the spray angle of the organic material 111 using the first, second, and third angle restriction members 115_1, 115_2, and 115_3, respectively, and thus the organic material 111 may be deposited in the effective deposition area of the substrate 130.

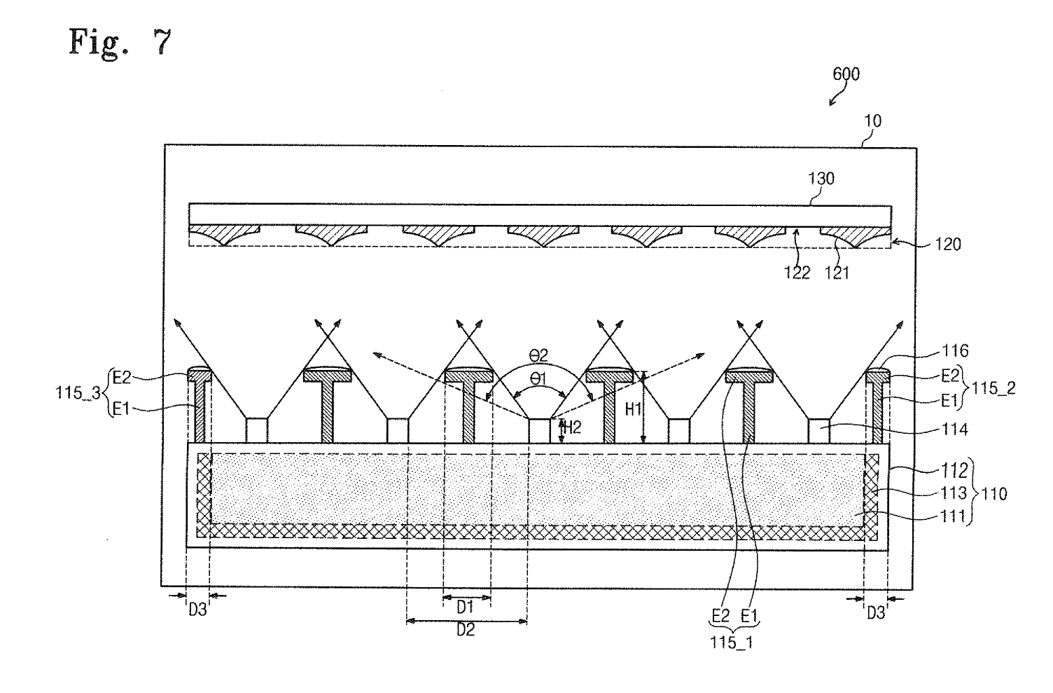

FIG. 7 is a view showing a deposition apparatus according to a sixth exemplary embodiment of the present invention.

The deposition apparatus 600 shown in FIG. 7 has the same structure and function as those of the deposition apparatus 500 shown in FIG. 6 except for first heater units 116. Accordingly, in FIG. 7, the same references denote the same elements in FIG. 6, and thus, detailed descriptions of the same elements will be omitted and different features will be mainly described.

Referring to FIG. 7, the first heater units 116 are respectively provided on upper surfaces of first angle restriction members 115_1, a second angle restriction member 115_2, and a third angle restriction member 115_3 so as to cover the whole upper surfaces of the first, second, and third angle restriction members 115_1, 115_2, and 115_3. Other parts of the deposition apparatus 600 have the same structure and function as those of the deposition apparatus 500 shown in FIG. 6, and thus detailed descriptions of the other parts will be omitted.

Although exemplary embodiments of the present invention have been described, it is to be understood that the present invention should not be limited to these exemplary embodiments but various changes and modifications can be made by those of ordinary skill in the art within the spirit and scope of the present invention as hereinafter claimed.

What is claimed is:

1. A deposition apparatus, comprising:
a deposition source unit that vaporizes a deposition material;
a plurality of nozzles disposed on an upper surface of the deposition source unit for spraying the vaporized deposition material onto a substrate facing the upper surface of the deposition source unit;
a plurality of angle restriction members disposed on the upper surface of the deposition source unit and located at left and right sides of the nozzles; and
a plurality of first heater units, each of which is disposed on an upper surface of a corresponding angle restriction member.

2. The deposition apparatus of claim 1, wherein the deposition source unit comprises:
a crucible filled with the deposition material; and
a second heater unit that heats the crucible so as to vaporize the deposition material.

3. The deposition apparatus of claim 2, wherein the first heater units generate a temperature higher than a temperature generated by the second heater unit.

4. The deposition apparatus of claim 1, wherein the angle restriction members comprise:
a plurality of first angle restriction members, each of which is disposed at the left side of a corresponding nozzle; and
a plurality of second angle restriction members, each of which is disposed at the right side of the corresponding nozzle.

5. The deposition apparatus of claim 4, wherein the vaporized deposition material sprayed from the nozzles has a spray angle restricted to a predetermined angle by the first and second angle restriction members.

6. The deposition apparatus of claim 5, wherein the substrate comprises a plurality of sub-pixel areas in which a plurality of sub-pixels is formed, and a plurality of effective deposition areas respectively corresponding to the sub-pixel areas, and each of the effective deposition areas has a width wider than a width of each of the sub-pixel areas.

7. The deposition apparatus of claim 6, wherein the predetermined angle is set to an angle to allow the vaporized deposition material to be deposited in the effective deposition areas.

8. The deposition apparatus of claim 1, wherein a first height corresponding to a height between the upper surface of the deposition source unit and the upper surface of the angle restriction members is set higher than a second height corresponding to a height between the upper surface of the deposition source unit and an upper surface of the nozzles.

9. The deposition apparatus of claim 1, wherein each of the first heater units has one of a semi-circular shape, a rectangular shape, a square shape, a semi-oval shape, and a rectangular shape with rounded corners.

10. A deposition apparatus, comprising:
a deposition source unit that vaporizes a deposition material;
a plurality of nozzles disposed on an upper surface of the deposition source unit for spraying the vaporized deposition material onto a substrate facing the upper surface of the deposition source unit;
a plurality of angle restriction members disposed on the upper surface of the deposition source unit; and
a plurality of heater units, each of which is disposed on an upper surface of a corresponding angle restriction member, the angle restriction members comprising:
a plurality of first angle restriction members disposed between the nozzles;
a second angle restriction member located at a right side of a nozzle disposed at a rightmost position among the nozzles; and
a third angle restriction member located at a left side of a nozzle disposed at a leftmost position among the nozzles.

11. The deposition apparatus of claim 10, wherein each of the first angle restriction members has a first width smaller than a second width defined by a width between two nozzles adjacent to each other and greater than one-half of the second width.

12. The deposition apparatus of claim 10, wherein each of the first angle restriction members has a first width smaller than one-half of a second width defined by a width between two nozzles adjacent to each other.

13. The deposition apparatus of claim 10, wherein the heater units comprise:
a plurality of first sub-heater units, each of which is located at a left portion of the upper surface of the corresponding angle restriction member, the second angle restriction member, and the third angle restriction member; and
a plurality of second sub-heater units, each of which is located at a right portion of the upper surface of the corresponding angle restriction member of the first angle restriction members, the second angle restriction member, and the third angle restriction member.

14. The deposition apparatus of claim 10, wherein each of the heater units covers the upper surface of a corresponding angle restriction member of the first angle restriction members, the second angle restriction member, and the third angle restriction member.

15. The deposition apparatus of claim 10, wherein each of the first angle restriction members, the second angle restriction member, and the third angle restriction member has a T shape.
